(19) United States
(12) Patent Application Publication
(10) Pub. No.: US 2026/0029701 A1
(43) Pub. Date: Jan. 29, 2026

(54) LIGHT SOURCE DEVICE AND PROJECTION-TYPE VIDEO DISPLAY DEVICE

(71) Applicant: Panasonic Projector & Display Corporation, Osaka (JP)

(72) Inventors: Yoshiki TANAKA, Kyoto (JP); Takashi IKEDA, Osaka (JP); Shuichiro YAMADA, Osaka (JP); Manabu OKUNO, Osaka (JP)

(21) Appl. No.: 19/343,073

(22) Filed: Sep. 29, 2025

Related U.S. Application Data
(63) Continuation of application No. PCT/JP2024/013134, filed on Mar. 29, 2024.

(30) Foreign Application Priority Data
Mar. 31, 2023 (JP) 2023-057737

(51) Int. Cl. G03B 21/20

(52) U.S. Cl. CPC G03B 21/204; G03B 21/208

(57) ABSTRACT

A light source device includes: an excitation light source; a phosphor wheel; a light guide optical system; and a color wheel, wherein the phosphor wheel includes: a substrate; a phosphor region provided on a first surface of the substrate, the phosphor region having phosphor that converts light from the excitation light source into fluorescent light; and a light processing region provided on a second surface of the substrate at a position corresponding, in a front-back direction, to the phosphor region; an opening provided from the first surface to the second surface of the substrate; and a drive device that rotates the substrate.

### CROSS-REFERENCE TO RELATED APPLICATIONS

This application is a Continuation of International Application No. PCT/JP2024/013134 filed on Mar. 29, 2024, which claims the benefit of foreign priority to Japan Patent Application No. 2023-57737 filed on Mar. 31, 2023, the entire contents of each of which are hereby incorporated by reference.

### BACKGROUND OF THE INVENTION

### 1. Field of the Invention

The present disclosure relates to a light source device used for a projection-type video display device, for example.

### 2. Description of the Related Art

Conventionally, as a light source for a projection-type video display device, there is used a light source device using a phosphor wheel having a phosphor layer that generates fluorescent light by blue excitation light and an opening that transmits the blue excitation light (see JP 2020-64269 A, for example).

In the above light source device, the phosphor layer of the phosphor wheel is irradiated with blue light serving as excitation light to generate fluorescent light, and the phosphor wheel is rotated to transmit the blue light through the opening, thereby generating combined light in which the transmitted blue light serving as excitation light and the fluorescent light generated before and/or after the blue light are arranged in time series by an optical system including a mirror and the like.

### SUMMARY

In a light source device using a phosphor wheel similar to the light source device in JP 2020-64269 A, the light source device includes a relay optical system for combining, with the fluorescent light, the blue light serving as excitation light having passed through the opening of the phosphor wheel. The inventor has found that the relay optical system has a problem of backward traveling light in which the blue light serving as excitation light from the light source travels backward through the optical system. For example, in a case of a light source device as illustrated in FIG. 1, the following case may occur. Part of the blue light 5a serving as excitation light from the light source 1a, 1b is reflected by a dichroic mirror 6 and enters the optical system 22, reaches a back surface of the phosphor wheel 10 after traveling backward as a backward traveling light (blue light) 5b, as indicated by the long dotted lines. The backward traveling light (blue light) 5b is reflected by the back surface of the phosphor wheel 10 to become a return light (blue light) 5c, as indicated by the short dotted lines. The return light (blue light) 5c passes through the same optical path through which the blue light 5a transmitted through the opening of the phosphor wheel 10 passes, returning to the dichroic mirror 6. Then, as a result, the return light (blue light) 5c causes a color mixing problem between fluorescent light 18 corresponding to the rotation state of the phosphor wheel 10 and the return light (blue light) 5c.

The present disclosure is intended to solve the above-mentioned problems, and one non-limiting and exemplary embodiments provides a light source device capable of emitting colors having high color purity by suppressing the following color mixing. Blue light that is part of the blue light serving as excitation light from a laser light source is reflected by a dichroic mirror and has thereby become backward traveling light, and the backward traveling light is reflected by a back surface of a phosphor wheel and has thereby become return light, and the blue light that has become the return light is mixed with fluorescent light.

In one general aspect, the techniques disclosed here feature: a light source device includes:
an excitation light source;
a phosphor wheel;
a light guide optical system; and
a color wheel,
wherein the phosphor wheel includes:
   a substrate;
   a phosphor region provided on a first surface of the substrate, the phosphor region having phosphor that converts light from the excitation light source into fluorescent light; and
   a light processing region provided on a second surface of the substrate at a position corresponding, in a front-back direction, to the phosphor region;
   an opening provided from the first surface to the second surface of the substrate; and
   a drive device that rotates the substrate.

The light source device according to the present disclosure includes a light processing region (diffusion layer) on the back surface side of the phosphor wheel, the light processing region being configured to diffuse blue light (backward traveling light) that is part of the blue light serving as excitation light from the laser light source, is reflected by the dichroic mirror, and has reached the back surface of the phosphor wheel. Therefore, the return light generated by reflection of the blue light (backward traveling light) on a back surface side of the phosphor wheel can be suppressed, and as a result, color mixing of the return light with the fluorescent light can be suppressed, so that color purity of the fluorescent light can be improved.

Additional benefits and advantages of the disclosed embodiments will be apparent from the specification and figures. The benefits and/or advantages may be individually provided by the various embodiments and features of the specification and drawings disclosure, and need not all be provided in order to obtain one or more of the same.

### BRIEF DESCRIPTION OF DRAWINGS

The present disclosure will become readily understood from the following description of non-limiting and exemplary embodiments thereof made with reference to the accompanying drawings, in which like parts are designated by like reference numeral and in which:

FIG. 1 is a schematic diagram illustrating a configuration of a light source device according to a first embodiment and a projection-type video display device including the light source device;

FIG. 2A is a schematic plan view illustrating an optical path of blue excitation light from a light source and an optical path of blue excitation light transmitted through a phosphor wheel in the light source device of FIG. 1;

FIG. 2B is a schematic perspective view illustrating a three-dimensional structure of the light source;

FIG. 3A is a schematic diagram illustrating a configuration of a front surface of the phosphor wheel in the light source device of FIG. 1;

FIG. 3B is a schematic diagram illustrating a configuration of a back surface of the phosphor wheel in the light source device of FIG. 1;

FIG. 4A is a schematic diagram illustrating a configuration of a light source device according to a second embodiment;

FIG. 4B is a schematic perspective view illustrating a polarization direction of light emitted from the light source device in FIG. 4A;

FIG. 4C is a schematic perspective view illustrating a configuration of a magenta color wheel in FIG. 4A;

FIG. 5 is a schematic diagram for describing two color modes realized by phase shift using the magenta color wheel of FIG. 4C;

FIG. 6A is a schematic diagram illustrating a magenta segment and a colorless segment in color mode 1 of a magenta color wheel;

FIG. 6B is a schematic diagram illustrating a light processing region on a back surface side of a phosphor wheel in a light source device according to the first modification;

FIG. 7A is a schematic plan view illustrating a state in which fins are provided on a back surface side (second surface) of a phosphor wheel of a light source device according to a second modification;

FIG. 7B is a schematic cross-sectional view illustrating a state in which blue light that is incident between the fins in FIG. 7A is repeatedly reflected by side surfaces and bottom surfaces of the fins; and

FIG. 8 is a schematic diagram illustrating a configuration of a projection-type video display device according to a third embodiment on which the light source device according to the first or second embodiment is mounted.

### DETAILED DESCRIPTION

A light source device according to a first aspect, includes:
an excitation light source;
a phosphor wheel;
a light guide optical system; and
a color wheel,
wherein the phosphor wheel includes:
   a substrate;
   a phosphor region provided on a first surface of the substrate, the phosphor region having phosphor that converts light from the excitation light source into fluorescent light; and
   a light processing region provided on a second surface of the substrate at a position corresponding, in a front-back direction, to the phosphor region; an opening provided from the first surface to the second surface of the substrate; and
   a drive device that rotates the substrate.

In the light source device according to a second aspect in addition to the first aspect, the light guide optical system may guide most part of the light from the excitation light source to a first surface of the phosphor wheel, and may combine transmitted light that is transmitted through the opening and the fluorescent light to generate combined light;
at a same time, a residual part of the light from the excitation light source may propagate through the light guide optical system in a direction different from a direction of the transmitted light without passing through the opening of the phosphor wheel and become backward traveling light that reaches a second surface of the phosphor wheel,
the light processing region may have a diffusion layer that diffuse-reflects the backward traveling light, and
the color wheel may be provided at a position where the combined light is incident.

In the light source device according to a third aspect in addition to the first or second aspect, the color wheel may include a filter that transmits red light and blue light and reflect light other than the red light and the blue light.

In the light source device according to a fourth aspect in addition to any one of the first to third aspects, the phosphor wheel may be provided with a diffusion layer on the second surface that is a back surface of the phosphor region that corresponds, on the first surface, to the filter.

In the light source device according to a fifth aspect in addition to the fourth aspect, the diffusion layer may have a fine uneven structure.

In the light source device according to a sixth aspect in addition to any one of the first to fifth aspects, the excitation light source may emit blue light with first polarization,
the light source device further may include a dichroic mirror that is the light combining element and is provided at a position between the excitation light source and the phosphor wheel, the dichroic mirror transmitting the blue light and reflecting the fluorescent light, and
the dichroic mirror may have a transmittance for the blue light with the first polarization higher than a transmittance for blue light with second polarization having a polarization direction different from a polarization direction of the first polarization.

In the light source device according to a seventh aspect in addition to the sixth aspect, the first polarization may be P-polarization and the second polarization may be S-polarization.

In the light source device according to eighth aspect in addition to the fourth aspect, the phosphor wheel may include a plurality of fins on the second surface that is a back surface of the phosphor region corresponding, on the first surface, to the filter, and
the diffusion layer may be provided on side surfaces of the fins and a bottom surface between each of the fins and another of the fins.

In the light source device according to ninth aspect in addition to eighth aspect, the diffusion layer may be also provided on top surfaces of the fins.

A projection-type video display device according to a tenth aspect, includes the light source device according to any one of the first to ninth aspects.

Hereinafter, embodiments will be described in detail with reference to the drawings as appropriate. However, unnecessarily detailed description may be omitted. For example, a detailed description of already well-known matters and repeated description of substantially the same configuration may be omitted. This is to prevent the following description from being unnecessarily redundant and to facilitate those skilled in the art to understand the present disclosure. In the drawings, substantially the same members are denoted by the same reference signs.

Note that the accompanying drawings and the following description are provided for those skilled in the art to fully understand the present disclosure, and are not intended to limit the subject matter described in the claims.

### First Embodiment

### [Configuration of Light Source Device]

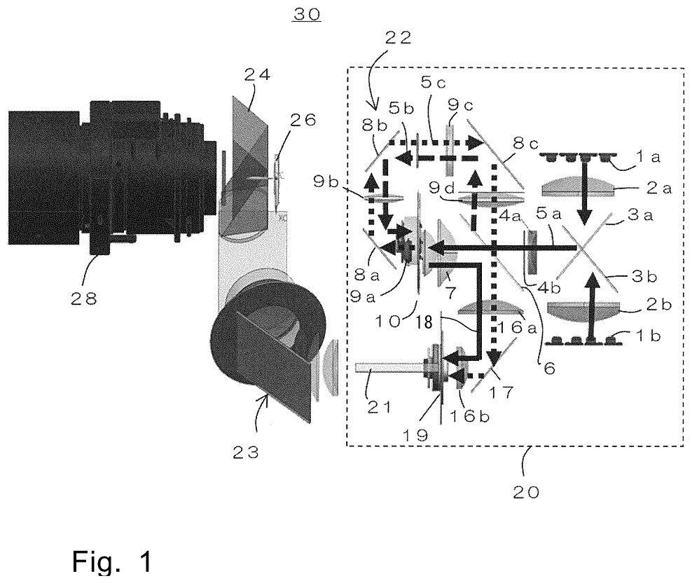

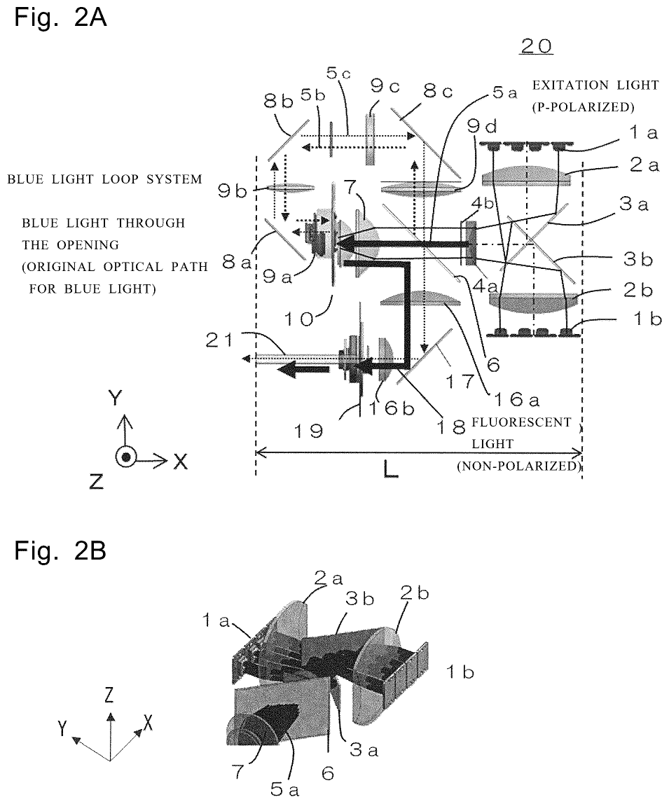

FIG. 1 is a schematic diagram illustrating a configuration of a light source device 20 according to a first embodiment and a projection-type video display device 30 including the light source device 20. FIG. 2A is a schematic plan view illustrating an optical path of blue light 5a serving as excitation light from the laser light sources 1a and 1b and an optical path of the blue light 5a transmitted through the phosphor wheel 10 in the light source device 20 in FIG. 1. For convenience, in FIG. 2A, a direction of the blue excitation light applied from the laser light sources 1a and 1b to the phosphor wheel 10 is defined as a −X direction, a plane including a loop drawn by the blue excitation light 5a transmitted through an opening is defined as an XY plane, and a direction perpendicular to the XY plane is defined as a Z direction.

The light source device 20 according to the first embodiment includes: the laser light sources 1a and 1b that emit laser light; the phosphor wheel 10 that converts the light (laser light) from the laser light sources 1a and 1b into fluorescent light; a light combining element 6 that combines the light from the laser light sources 1a and 1b with the fluorescent light to generate combined light arranged in the time series, and a color wheel 19 provided at a position where the combined light is incident. The phosphor wheel 10 includes: a substrate 11; a phosphor region 13 provided on a first surface of the substrate 11 and having a phosphor that converts the light from the laser light sources la and 1b into the fluorescent light; an opening 14 provided from the first surface to a second surface of the substrate 11; and a light processing region 15 provided on the second surface of the substrate 11 and having a diffusion layer that diffuses blue light (backward traveling light) 5b that is part of the blue light 5a serving as excitation light from the laser light sources 1a and 1b, is reflected by the dichroic mirror 6, and then has reached a back surface of the phosphor wheel 10.

As illustrated in FIG. 2A, the blue light 5a emitted from the laser light sources 1a and 1b is reflected by mirrors 3a and 3b via lenses 2a and 2b and enters a diffusion plate 4b via a concave lens 4a. A light beam of the blue light 5a is diffused, and the blue light 5a passes through the dichroic mirror 6, and is emitted to the phosphor wheel 10 via a lens 7. The blue light 5a that is applied to the phosphor wheel 10 generates fluorescent light 18 when the phosphor in the phosphor region 13 is irradiated in accordance with the rotation of the phosphor wheel 10, and the fluorescent light 18 is reflected by the dichroic mirror 6 by the lens 7, and is applied to the color wheel 19 via lenses 16a and 16b and a mirror 17. On the other hand, the blue light 5a having passed through the opening 14 passes from the back surface of the phosphor wheel 10 through an optical path configured with three mirrors 8a, 8b, and 8c and four lenses 9a, 9b, 9c, and 9d, is transmitted through the dichroic mirror 6, is combined with the fluorescent light 18 to generate a combined light arranged in the time series, and the combined light is applied to the color wheel 19 via the lenses 16a and 16b and the mirror 17. The fluorescent light having a wide wavelength range is filtered by the color wheel 19, and output light in which pieces of light having colors as a light source are arranged in time series is obtained and output via a rod 21.

According to the light source device 20, the light processing region (diffusion layer) 15 is provided on the back surface side of the phosphor wheel 10, and the light processing region (diffusion layer) 15 diffuses the blue light (backward traveling light) 5b that is part of the blue light 5a serving as excitation light from the laser light sources la and 1b. The blue light 5a is reflected by the dichroic mirror 6, and then has reached the back surface of the phosphor wheel 10 as the blue light (backward traveling light) 5b. Therefore, it is possible to suppress return light 5c caused by the reflection of the backward traveling light 5b by the back surface side of the phosphor wheel 10, and as a result, it is possible to suppress color mixing of the return light 5c with the fluorescent light 18. As a result, each of the colors with high color purity can be emitted.

Hereinafter, members constituting the light source device 20 will be described.

### <Excitation Light Source>

FIG. 2B is a schematic perspective view illustrating a three-dimensional structure of the laser light sources 1a and 1b. The laser light sources 1a and 1b emit laser light. For example, the laser light sources 1a and 1b may emit blue light. Furthermore, as in the light source device according to a second embodiment, blue light with a first polarization (for example, P-polarization) may be emitted.

For example, as illustrated in FIG. 2B, the laser light sources 1a and 1b serving as excitation light source may be configured, for example, such that blue LD rows provided at different heights in the Z direction are opposed to each other. The convex lenses 2a and 2b each may be used to converge a beam of light, thereby reducing widths of the light beams. The light beams may be reflected by the mirrors 3a and 3b whose inclinations are adjusted, so that directions of the opposing light beams are aligned so as to be parallel, and the light beams may be then made to be parallel and guided to the dichroic mirror 6 by using the concave lens 4a or the like, for example. As a result, a length L of the light source device 20 in a depth direction (X direction) can be shortened as compared with a case where the width of the light beam is reduced after the laser light beams are combined, and as a result, space saving can be realized. In addition, since many LDs can be disposed in a small area, high luminance can be obtained. Furthermore, the diffusion plate 4b may be provided behind the concave lens 4a. By using the diffusion plate 4b to improve uniformity of spatial intensity distribution of the excitation light 5a and to adjust a diffusion angle of transmitted light, it is possible to control an excitation light spot size when the excitation light enters the phosphor wheel 10. As the excitation light spot size is smaller, the fluorescent light emitted from the phosphor wheel 10 is transmitted through the subsequent optical system with higher efficiency (optical system transmission efficiency). However, since light density on the phosphor wheel is higher, luminous efficiency of the phosphor tends to be lower. In contrast, when the excitation light spot size is larger, luminous efficiency of the phosphor tends to be higher, but the optical system transmission efficiency of the fluorescent light in the optical system tends to be lower. Therefore, the diffusion plate 4b is desirably made so as to realize the excitation light spot size that maximizes a final efficiency obtained by multiplying the luminous efficiency and the optical system transmission efficiency.

### <Phosphor Wheel>

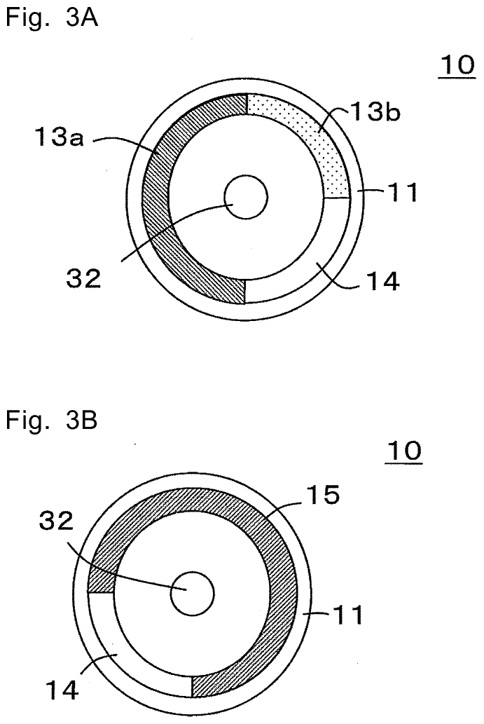

FIG. 3A is a schematic diagram illustrating a configuration of the front surface of the phosphor wheel 10 in the light source device 20 of FIG. 1. FIG. 3B is a schematic diagram illustrating a configuration of the back surface of the phosphor wheel 10 in the light source device of FIG. 1.

The phosphor wheel 10 includes: the substrate 11; phosphor regions 13a and 13b provided on a front surface (first surface) of the substrate 11 and having phosphors that convert the light from the laser light sources 1a and 1b into the fluorescent light; an opening 14 provided from the front surface (first surface) to a back surface (second surface) of the substrate 11; and the light processing region 15 provided on the back surface (second surface) of the substrate 11 and having a diffusion layer that reflects the blue light (backward traveling light) 5b that is part of the blue light 5a serving as excitation light from the laser light sources 1a and 1b, is reflected by the dichroic mirror 6, and has reached the back surface of the phosphor wheel 10. The phosphor wheel 10 is provided with a motor. The phosphor regions 13a and 13b and the opening 14 are arranged in a circular shape centering on a rotation axis of the motor such that the blue light 5a serving as excitation light converged by the lens 7 enters within regions that are at the same radial distance from a rotation center and that the phosphor regions 13a and 13b and the opening 14 are arranged on.

Hereinafter, members constituting the phosphor wheel 10 will be described.

### <Substrate>

The substrate 11 may be, for example, a rotatable substrate. The substrate 11 may have, for example, a disk shape. Alternatively, the substrate 11 may have a polygonal shape. The substrate 11 may be, for example, an aluminum substrate having excellent heat dissipation. The substrate does not need to be aluminum, and may be made of another metal. A transparent substrate such as glass or sapphire may be used, and a reflective region may be provided on a transparent substrate such as glass or sapphire. As illustrated in FIGS. 3A and 3B, the substrate 11 may be provided with a motor mounting hole 32 for mounting a motor for rotation. Alternatively, the substrate 11 may be mounted on the motor by a method other than the motor mounting hole 32.

### <Phosphor Region>

In the phosphor regions 13a and 13b, phosphors are included in a binder. For example, the phosphor region 13a may be a region including a phosphor that generates yellow fluorescent light, and the phosphor region 13b may have a phosphor that generates green fluorescent light. The yellow fluorescent light may partially contain red fluorescent light. Also in a case where red fluorescent light is included in yellow fluorescent light, it is possible to select light in a wavelength range to be used as light of each color of the light source by filtering with a color wheel to be described later, and also in the above case, yellow light and red light can be obtained.

For example, as illustrated in FIG. 3A, the phosphor regions 13a and 13b may be provided circumferentially with respect to the rotation center.

### <Phosphor>

The phosphor may be, for example, particles having a garnet structure. A chemical formula of the garnet structure may be, for example, Y₃Al₅O₁₂ that wavelength-converts blue excitation light into yellow fluorescent light or Lu₃Al₅O₁₂ that wavelength-converts blue excitation light into green fluorescent light. Alternatively, the phosphor may be (Y, Lu)₃Al₅O₁₂ that is a mixture of Y₃Al₅O₁₂ and Lu₃Al₅O₁₂. An activator may be, for example, Ce or Gd. The phosphor may be particles that convert blue excitation light into fluorescent light other than the above-described yellow and green. As the phosphor, a red phosphor such as (Sr, Ca)AlSiN₃:Eu²⁺ or CaAlSiN₃:Eu²⁺ may be used. By changing the configuration and composition, a wavelength to which excitation light is wavelength-converted can be variously changed.

### <Binder>

The binder is a medium in which the phosphor is dispersed, and may be, for example, a heat-resistant transparent resin such as silicone resin or polysilsesquioxane, or glass such as silicon dioxide or silicate glass.

### <Opening>

The opening 14 is provided from the front surface (first surface) to the back surface (second surface) of the substrate 11. One or more openings 14 may be provided. The blue light 5a from the laser light sources 1a and 1b passes through the opening, passes from the back surface of the phosphor wheel 10 through an optical path constituted by the three mirrors 8a, 8b, and 8c and lenses 9a, 9b, 9c, and 9d, passes through the dichroic mirror 6 that is a light combining element, and is combined with the fluorescent light to generate a combined light arranged in the time series.

### <Light Processing Region>

The light processing region 15 is provided on the back surface (second surface) of the substrate 11, and has the diffusion layer that diffuses the blue light (backward traveling light) 5b, which is part of the blue light 5a serving as excitation light from the laser light sources 1a and 1b, is reflected by the dichroic mirror 6, and has reached the back surface of the phosphor wheel 10. The diffusion layer has, for example, a fine uneven structure formed by sandblasting, but is not limited thereto. For example, the diffusion layer may be configured with a member to which a light diffusing glass plate is attached. Alternatively, a mixture of a thermosetting resin and a powder may be applied and cured to form the diffusion layer. By providing the diffusion layer, it is possible to suppress return light 5c caused by reflection of the backward traveling light 5b on the back surface side of the phosphor wheel 10, and a residual ratio of the return light in the fluorescent light can be reduced to about half or less. This is considered to be because of the following reason. Since the backward traveling light is reflected by the diffusion layer, the backward traveling light is diffused and does not enter an effective area of at least one of the lenses and mirrors constituting a blue loop system. Alternatively, instead of the diffusion layer, a light absorbing layer may be provided that is coated with a black paint by a black anodizing treatment or the like and absorbs the backward traveling light. In the case of the light absorbing layer, the residual ratio of the return light in the fluorescent light can be approximately 30% or less. Although the back surface of the phosphor wheel 10 may be a flat surface, the back surface may be provided with fins in order to enhance cooling performance of the phosphor wheel 10, for example. This arrangement makes it possible to improve an upper limit of excitation light intensity, and high luminance can be realized. Even when the fins are provided, the diffusion layer can be provided.

### <Light Combining Element (Dichroic Mirror)>

The light combining element 6 combines the blue light 5a from the laser light sources 1a and 1b and the fluorescent light 18 to generate combined light in which the blue light 5a and the fluorescent light 18 are arranged at different times, that is, arranged in time series or along the time axis. The light combining element 6 is, for example, a dichroic mirror (color separation and combination mirror). The dichroic mirror 6 is provided between the laser light sources 1a and 1b and the phosphor wheel 10, transmits the blue light, and reflects the fluorescent light. In the dichroic mirror 6, a transmittance for the blue light with the first polarization (P-polarization) may be higher than a transmittance for the blue light with the second polarization (S-polarization) having a polarization direction different from that of the first polarization. The dichroic mirror is formed by, for example, forming a dielectric multilayer film on a glass plate.

### <Relay Optical System>

The blue light 5a having passed through the opening 14 of the phosphor wheel 10 passes from the back surface of the phosphor wheel 10 through the optical path configured with the three mirrors 8a, 8b, and 8c and the four lenses 9a, 9b, 9c, and 9d, and passes through the dichroic mirror 6, thereby being combined with the fluorescent light 18. The three mirrors 8a, 8b, and 8c and the four lenses 9a, 9b, 9c, and 9d constitute a first relay optical system 22 for forming an optical path that returns the blue light 5a having passed through the opening 14 to the dichroic mirror 6. Note that the first relay optical system is configured here with the three mirrors 8a, 8b, and 8c and the four lenses 9a, 9b, 9c, and 9d; however, the present invention is not limited to this configuration, and another configuration may be used.

As described above, since the dichroic mirror 6 transmits the blue light 5a and reflects the yellow light as the fluorescent light, the yellow light 18 changes its traveling direction on the dichroic mirror 6 by 90 degrees, and is applied to the color wheel 19 via the lenses 16a and 16b and the mirror 17. On the other hand, the blue light 5a incident on the dichroic mirror 6 via the first relay optical system 22 is transmitted through the dichroic mirror 6, is combined with the yellow light 18 as the fluorescent light, and is applied, as the combined light, to the color wheel 19 via the lenses 16a and 16b and the mirror 17. The combined light referred to here is combined light in which the blue light serving as excitation light and the fluorescent light generated before and after the blue light are arranged along a time series.

### <Color Wheel>

The color wheel 19 is for obtaining light in a wavelength range that can be used as colors of the light source by filtering the fluorescent light 18 generated on the phosphor wheel 10. As the color wheel, a magenta color wheel may be used as described in the second embodiment described later, for example.

Fluorescent light 18 may include light in a relatively wide wavelength range as compared with the laser light. For example, as described above, the yellow fluorescent light may include light in a wavelength range from green to red. In such a case, when a magenta color wheel that transmits red light and blue light but blocks other light, red fluorescent light can be extracted from the yellow fluorescent light as described later.

### Second Embodiment

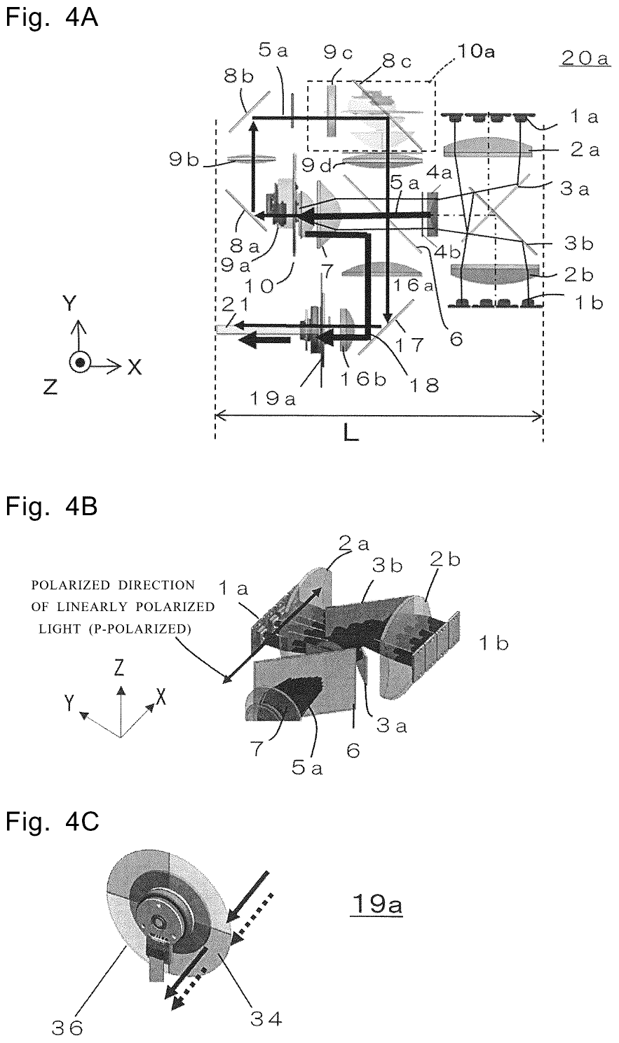

FIG. 4A is a schematic diagram illustrating a configuration of a light source device 20a according to the second embodiment.

As compared with the light source device according to the first embodiment, the light source device 20a according to the second embodiment has a first feature and a second feature. The first feature is that light emitted from the laser light sources 1a and 1b is blue light with the first polarization (for example, P-polarization). In addition, a second feature is that a color wheel 19a is a magenta color wheel.

The light source device 20a according to the second embodiment is configured such that the light emitted from the laser light sources 1a and 1b is P-polarized blue light, and a dichroic mirror 6 transmits the P-polarized blue light.

The laser light sources 1a and 1b have, for example, a rectangular shape as illustrated in FIG. 4B, and are elements in which a polarization direction of emitted light (linearly polarized light) is parallel to the short sides. In this case, in order to shorten a length L of the light source device 20a in the X direction, it is desirable to dispose the laser light sources 1a and 1b such that the short sides are aligned in the X direction. At this time, the polarization direction of the light emitted from the laser light sources 1a and 1b is the X direction. A polarization direction of the excitation light 5a that is light reflected and combined by the mirrors 3a and 3b is a Y direction, and a vibration plane of the excitation light 5a is parallel to a plane (XY plane) defined by incident light on and light reflected by the dichroic mirror 6; therefore, this light has P-polarization (first polarization) on the dichroic mirror 6.

The phosphor wheel 10 is disposed at a position where the excitation light 5a transmitted through the dichroic mirror 6 is incident. Here, the dichroic mirror 6 is a dichroic mirror that transmits the blue light and reflects the fluorescent light. As the dichroic mirror 6, a dichroic mirror may be used in which a transmittance for the blue light with the first polarization (P-polarization) is higher than a transmittance for the blue light with the second polarization (S-polarization). When the dichroic mirror is manufactured, the transmittance for P-polarization is easily made higher than the transmittance for S-polarization.

On the other hand, as a conventional light source device, there is a light source device configured to reflect S-polarized blue light on a dichroic mirror. That is, S-polarization is used for the blue light instead of P-polarization, and the dichroic mirror that reflects blue light and transmits fluorescent light is used as the dichroic mirror 6. At this time, a reflectance for the S-polarized blue light of the dichroic mirror is often higher than a reflectance for the P-polarized blue light. When making a dichroic mirror, the reflectance for the S-polarization is easily made higher than the reflectance for the P-polarization. In this configuration, the phosphor wheel is disposed at a position where S-polarized reflected light is incident from the dichroic mirror 6.

FIG. 4A illustrates a phosphor wheel 10a in a perspective manner assuming a case where the phosphor wheel is disposed at a position where the S-polarized reflected light is incident from the dichroic mirror 6 when such a configuration that the S-polarized light is reflected is used for the light source device 20a. In this case, the phosphor wheel 10a interferes with the laser light source 1a and a holding mechanism, a cooling member, and the like for the laser light source 1a, therefore, it is necessary to retract the excitation light source including the laser light source 1a and the lens 2a in the X direction. Therefore, the length L in the X direction becomes longer. In addition, in order to emit the S-polarized light, the laser light sources 1a and 2b are disposed such that the longer sides are aligned in the X direction, so that the length L in the X direction is further increased.

Therefore, as described above, by using the P-polarized blue light as transmitted light, space saving can be realized, while realizing high luminance, as compared with the case where the S-polarized blue light is reflected by the dichroic mirror 6.

In the case of the configuration in which the P-polarized blue light is transmitted through the dichroic mirror 6 as described above, efficiency of the dichroic mirror is worse than that in the case of the conventional configuration in which the S-polarized blue light is reflected by the dichroic mirror. For this reason, the P-polarized blue light 5a serving as excitation light may be reflected by the dichroic mirror 6 and become the backward traveling light 5b traveling backward through the first relay optical system 22, and the backward traveling light 5b may be reflected by the back surface of the phosphor wheel, thereby increasing the return light 5c that causes color mixing with the fluorescent light 18.

FIG. 4C is a schematic perspective view illustrating a configuration of the magenta color wheel 19a in FIG. 4A.

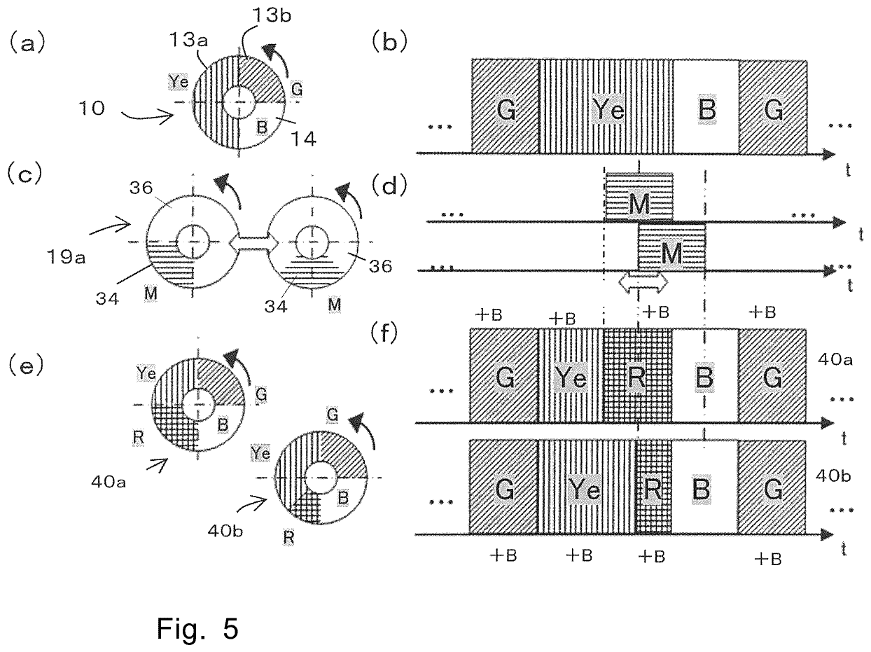

In the light source device 20a, the color wheel 19a includes a magenta color wheel having a magenta segment 34 that transmits blue light and red light and a colorless segment 36 that transmits light of all colors. Rotation of the magenta color wheel 19a is synchronized with rotation of the phosphor wheel 10. As described above, the yellow fluorescent light generated in the phosphor region 13a of the phosphor wheel 10 sometimes includes not only yellow light but also red light. In this case, only the red light included in the yellow fluorescent light is transmitted through the magenta segment 34, and the red light is therefore extracted. On the other hand, the fluorescent light 18 generated by the other portion of the phosphor regions 13a and 13b of the phosphor wheel 10 and the blue light 5a having passed through the opening 14 and combined by the dichroic mirror 6 via the first relay optical system 22 pass through the colorless segment 36 as they are. Thus, the respective colors of light are arranged along a time series.

<Two Color Modes by Phase Shift>FIG. 5 is a schematic diagram for describing two color modes realized by phase shift using the magenta color wheel of FIG. 4C.

There will be described the two color modes realized by phase shift using the magenta color wheel 19a and by two types of arrangements of the respective colors along a time series.

Similarly to FIG. 3A, the phosphor wheel 10 illustrated in a part (a) of FIG. 5 includes the phosphor region 13a that generates yellow fluorescent light Ye, the phosphor region 13b that generates green fluorescent light G, and the opening 14 through which the blue light B serving as excitation light passes. The phosphor region 13a that generates the yellow fluorescent light Ye occupies a semicircular portion on the left side, the phosphor region 13b that generates the green fluorescent light G occupies a ¼ portion on the upper right, and the opening 14 occupies a ¼ portion on lower right. The area ratio is not limited thereto, and a necessary area ratio may be adopted as appropriate.

A part (b) of FIG. 5 is a diagram illustrating the arrangement of light along a time series of the fluorescent light output by the rotation of the phosphor wheel 10 and the blue light serving as excitation light. As illustrated in the part (b) of FIG. 5, it can be seen that G, Ye, B, and G are output in this order along a time series by the rotation of the phosphor wheel. In this case, when the phosphor wheel rotates in a constant time, each color is output on the basis of a time width corresponding to the area ratio on the phosphor wheel 10.

A part (c) of FIG. 5 is a diagram illustrating a case of two color modes in which the position of the magenta segment 34 of the magenta color wheel 19a is made to correspond to the positions of the phosphor regions 13a and 13b of the phosphor wheel 10 of the part (a) of FIG. 5. A left side of the part (c) of FIG. 5 is color mode 1, and the magenta segment 34 is disposed on a lower-left ¼ portion, which corresponds to a half of the phosphor region 13a on the phosphor wheel 10 where the yellow fluorescent light Ye is generated. On the other hand, a right side of the part (c) of FIG. 5 is color mode 2, and a position of the magenta segment 34 is disposed over both the phosphor region 13a that generates the yellow fluorescent light Ye and the opening 14. The position of the magenta segment 34 illustrated on the left side and right side of the part (c) of FIG. 5 can be appropriately adjusted.

A part (d) of FIG. 5 is a diagram illustrating time ranges of filtering by the magenta segments corresponding to the two color modes on the left side and right side of the part (c) of FIG. 5.

A part (e) of FIG. 5 is a diagram illustrating a time series of each of output light 40a and 40b by using circular graphs in which time is shown in a circumferential direction. A left side of the figure is a circular graph of the output light 40a corresponding to color mode 1 of the part (c) of FIG. 5, and a right side of the figure is a circular graph of the output light 40b corresponding to color mode 2.

A part (f) of FIG. 5 is a diagram illustrating the time series of the output light with time on a horizontal axis. An upper side corresponds to color mode 1 of the part (c) of FIG. 5, and a lower side corresponds to color mode 2.

In color mode 1 and color mode 2, among the light from the phosphor wheel 10, red fluorescent light R contained therein is extracted from the yellow fluorescent light corresponding to the magenta segment 34, and the yellow fluorescent light is reflected and replaced with the red fluorescent light R. The difference between color mode 1 and color mode 2 is that there is a difference in a size of an overlapping area between the magenta segment 34 and the yellow fluorescent light Ye from the phosphor wheel 10. Color mode 1 having a high red luminance ratio, is used when a video having a vivid color is displayed, and color mode 1 is also referred to as a color priority mode. Color mode 2 having a high yellow luminance ratio, is used when a bright image is displayed, and color mode 2 is also referred to as a brightness priority mode.

When the magenta color wheel 19a is used, the following color mixing may be an issue. The magenta segment 34 transmits the blue light and the red light, so that the backward traveling light traveling backward through the first relay optical system 22 is reflected by the back surface of the phosphor wheel, thereby generating return light, and the blue light in the return light causes color mixing with the fluorescent light. For example, with respect to each color of the output light in the part (f) of FIG. 5, the color mixing caused by the blue light in the return light is indicated by “+B”. In particular, a case where the blue light causes color mixing with the red light is a problem.

Similarly to the first embodiment, the light source device 20a also has, on the back surface side of the phosphor wheel 10, a diffusion layer that diffuses the blue light (backward traveling light) 5b. The blue light (backward traveling light) 5b is part of the blue light 5a serving as excitation light from the laser light sources 1a and 1b, the blue light 5a is reflected by the dichroic mirror 6, and the reflected blue light has reached the back surface of the phosphor wheel 10 as backward traveling light (blue light) 5b. It is possible to suppress the return light 5c that is caused by the reflection of the backward traveling light 5b on the back surface side of the phosphor wheel 10, and as a result, it is possible to suppress color mixing of the return light 5c with the fluorescent light. As a result, each color having high color purity can be emitted.

### First Modification

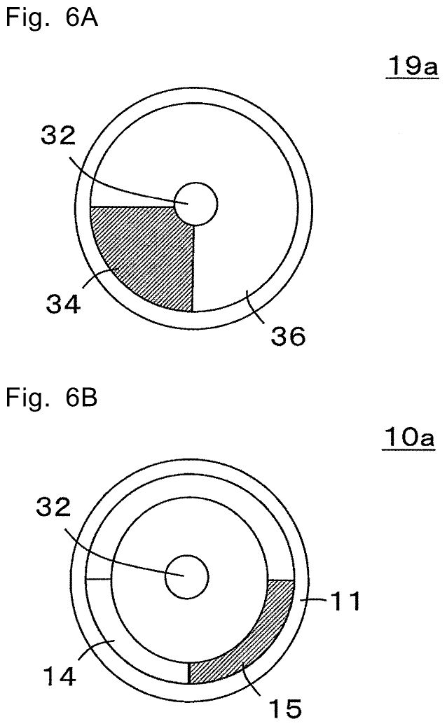

FIG. 6A is a schematic diagram illustrating the magenta segment 34 and the colorless segment 36 of the magenta color wheel 19a in color mode 1. FIG. 6B is a schematic diagram illustrating a light processing region 15 on a back surface side of a phosphor wheel 10a in a light source device according to a first modification.

The light source device according to the first modification is characterized in that the light processing region 15 on the back surface side of the phosphor wheel 10a is provided at a position corresponding to the magenta segment 34 of the magenta color wheel 19a.

As described above, a case where there is color mixing of the blue light with the red light is particularly a problem; therefore, when the light processing region (diffusion layer) 15 is provided on the back surface side of the phosphor wheel 10a in correspondence to the magenta segment 34 as described above, it is possible to suppress color mixing of the blue light in the return light with the red light. As a result, each color having high color purity can be emitted.

### Second Modification

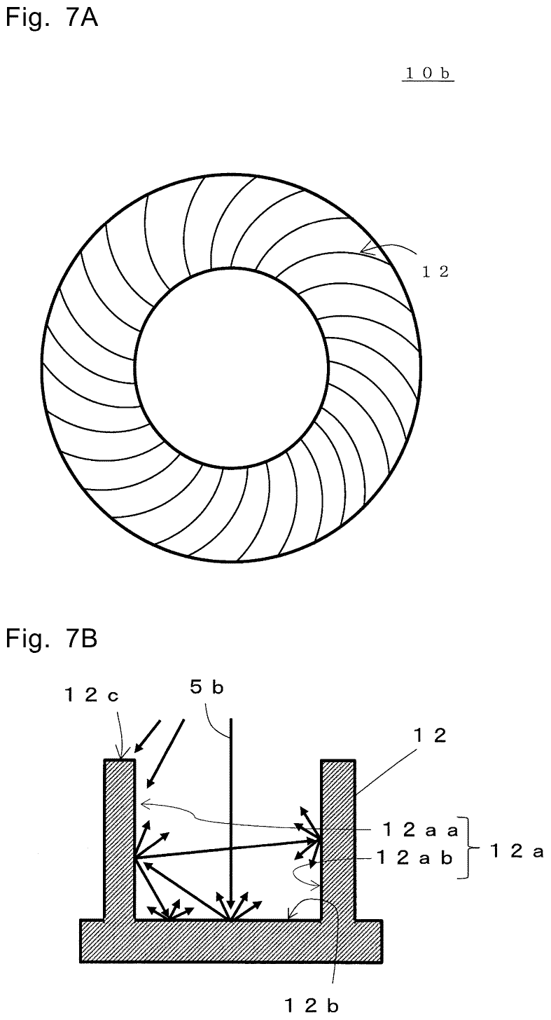

FIG. 7A is a schematic plan view illustrating a state in which fins are provided on a back surface side (second surface) of a phosphor wheel 10b of a light source device according to a second modification. FIG. 7B is a schematic sectional view of the fins 12 illustrating reflected blue light (backward traveling light) 5b between the fins 12 as the following state. The blue light (backward traveling light) 5b reflected by the dichroic mirror 6 and having reached a back surface of the phosphor wheel 10b is incident between fins 12 in FIG. 7A, and the blue light is repeatedly reflected by side surfaces 12a and a bottom surface 12b of the fins 12.

As illustrated in FIG. 7A, the phosphor wheel 10b of the light source device according to the second modification is provided with the fins 12 on the back surface side. As described above, the fins 12 are provided for enhancing cooling performance. The fins 12 may be formed integrally with the substrate of the phosphor wheel 10b. A plurality of fins 12 may be provided. Furthermore, the fins 12 do not need to be provided on the entire back surface, and may be provided on a part of the back surface, for example, on a portion that is a part of the back surface and corresponds, in a front-back direction, with the phosphor region on the front surface side. The fins 12 may have a shape of a straight line, a curved line, or a combination thereof. From the viewpoint of cooling performance, reduction in air resistance, low noise characteristics, and the like, the fins 12 may be provided point-symmetrically with respect to a center of the substrate of the phosphor wheel 10b. Further, a diffusion layer may be provided on side surfaces of the fins 12. A diffusion layer may be provided on the bottom surface between the fins. In addition, a diffusion layer may be provided on the top surfaces of the fins. The diffusion layer may have fine unevenness formed by sandblasting, for example.

By providing the fins on the back surface of the phosphor wheel 10b and providing a diffusion layers on the side surfaces of the fins, the bottom surfaces between the fins, and the top surfaces of the fins, a residual ratio of the return light 5c in which the blue light (backward traveling light) 5b reflected by the dichroic mirror 6 and having reached the back surface of the phosphor wheel 10b is reflected by the back surface of the phosphor wheel 10b can be made to be about 10%. Note that when the fins are not provided and the diffusion layer is not provided as in the conventional case, the residual ratio of the return light 5c is about 40%. In contrast, when the fins are not provided and the diffusion layer is provided as in the light source device according to the first embodiment, the residual ratio of the return light is about 20%, in which case the residual ratio of the return light 5c can be approximately 30% or less. The light source device according to the second modification has an excellent effect of further reducing the residual ratio of the return light.

As illustrated in FIG. 7B, when the fins 12 are provided, the blue light 5b that is reflected by the dichroic mirror 6 and then has reached the back surface of the phosphor wheel 10b is incident on the bottom surfaces 12b and the side surfaces 12a of the fins and the top surfaces 12c of the fins. In a case where the fins 12 are provided in which the side surfaces 12a and the bottom surfaces 12b of the fins 12 are also sandblasted, the blue light 5b incident on, for example, the bottom surface 12b between the fins 12 is diffuse-reflected, and part of the diffuse-reflected light is incident on one side surface 12aa of the fin 12 and then diffuse-reflected. Furthermore, part of the diffuse-reflected light is incident on the other side surface 12ab and the bottom surface 12b of the fins 12 and is diffuse-reflected. In this manner, between the fins 12, diffuse reflection is frequently repeated on the side surfaces 12a of the fins 12 and the bottom surface 12b. Of course, light incident on the side surface 12ab after being incident on and diffuse-reflected by the bottom surface 12b and light incident on the side surface 12aa or the side surface 12ab not via the bottom surface 12b are repeatedly diffuse-reflected in the same manner above. Therefore, it is considered that the light source device according to the second modification including the phosphor wheel having the fins 12 subjected to sandblasting has a higher effect of reducing the blue light reflected by the back surface than in the case of being sandblasted but having no fins. When the top surfaces 12c of the fins are also sandblasted, the light incident on the top surfaces 12c of the fins is also diffuse-reflected.

Note that since the material of the fins absorbs some light, it is considered that there is an additional effect that light is further absorbed while the reflected blue light 5b is repeatedly incident and diffuse-reflected on the side surfaces 12a, the bottom surface 12b, and the like of the fins 12.

Note that, in order to enhance cooling performance of the phosphor wheel 10, the substrate 11 may be a metal plate, and the back surface of the substrate 11 may be subjected to plating (electrodeposited film), etching, protective film application, laser processing, or the like to form a micro-texture structure. The micro-texture structure may be appropriately designed to have a function as a light diffusion layer. Such a micro-texture structure can be provided even when there are fins and even after sandblasting.

### Third Embodiment

### <Projection-Type Video Display Device>

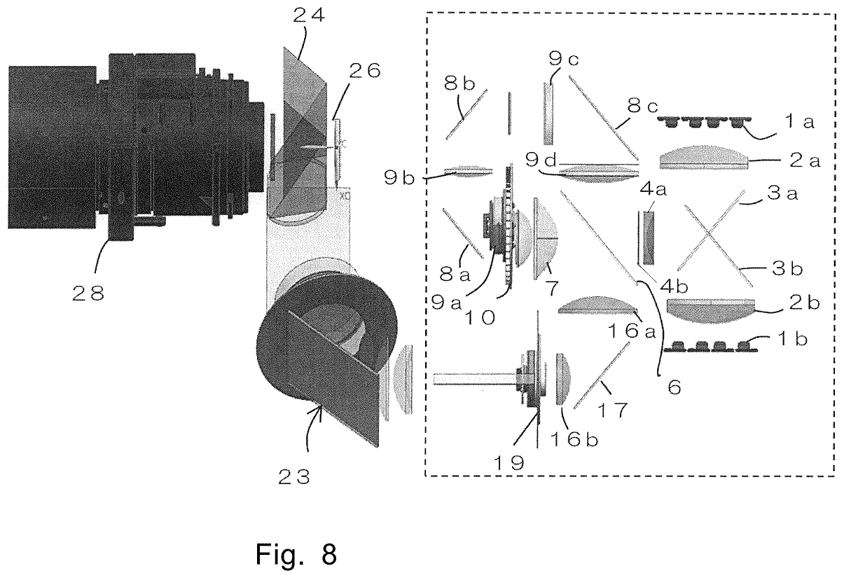

FIG. 8 is a schematic diagram illustrating a configuration of a projection-type video display device 30 using the light source device 20 or 20a according to the first or second embodiment.

Note that, since the configurations of the light source devices 20 and 20a according to the first and second embodiments have been described above, a description thereof will be omitted here, and output light after being emitted from the light source device 20 or 20a will be described.

The light emitted from the light source device 20 or 20a enters a total reflection prism 24 via a second relay lens system 23. The light incident on the total reflection prism 24 is incident on a minute gap of the total reflection prism 24 at an angle equal to or larger than a total reflection angle and is reflected, so that a traveling direction of the light is changed so as to be incident on a DMD 26. The DMD 26 emits the light after changing the traveling direction of the light by changing directions of micromirrors in synchronization with the output light emitted by a combination of the phosphor wheel 10, 10a, or 10b and the color filter 19 or 19a, according to a signal from a video circuit (not illustrated).

The light whose traveling direction is changed by the DMD 26 according to the video signal is incident on the minute gap of the total reflection prism 24 at an angle less than the total reflection angle, so that the light is transmitted as it is and is incident on a projection lens 28, and the light is projected on a screen (not illustrated).

Note that the present disclosure includes an appropriate combination of arbitrary embodiments and/or examples among the various embodiments and/or examples described above, and effects of the respective embodiments and/or examples can be exhibited.

The light source device according to the present disclosure includes a light processing region (diffusion layer) on a back surface side of a phosphor wheel, the light processing region being configured to diffuse blue light (backward traveling light) that is part of blue light serving as excitation light from a laser light source, is reflected by the dichroic mirror, and has reached the back surface of the phosphor wheel. Therefore, it is possible to suppress return light caused by reflection of the blue light (backward traveling light) on the back surface side of the phosphor wheel, and as a result, it is possible to suppress color mixing of the return light with the fluorescent light, and it is useful as a light source device used for a projection-type video display device capable of emitting colors having high color purity.

### REFERENCE SIGNS LIST

1a, 1b laser light source
2a, 2b lens
3a, 3b mirror
4a concave lens
4b diffusion plate
5a blue light serving as excitation light
5b blue light (backward traveling light) reflected by dichroic mirror
5c blue light (return light) reflected by back surface of phosphor wheel
6 dichroic mirror
7 lens
8a, 8b, 8c mirror
9a, 9b, 9c lens
10, 10a phosphor wheel
11 substrate
12 fin
12a, 12aa, 12ab side surface
12b bottom surface
12c top surface
13 phosphor region
13a phosphor region (yellow)
13b phosphor region (green)
14 opening
15 light processing region (diffusion layer)
16a, 16b lens
17 mirror
8 fluorescent light
19, 19a color wheel
20, 20a light source device
21 rod
22 first relay optical system
23 second relay optical system
24 total reflection prism
26 DMD
28 projection lens
30 projection-type video display device
32 motor mounting hole
34 magenta segment
36 colorless segment
40 output light

1. A light source device comprising:
an excitation light source;
a phosphor wheel;
a light guide optical system; and
a color wheel,
wherein the phosphor wheel includes:
a substrate;
a phosphor region provided on a first surface of the substrate, the phosphor region having phosphor that converts light from the excitation light source into fluorescent light; and
a light processing region provided on a second surface of the substrate at a position corresponding, in a front-back direction, to the phosphor region;
an opening provided from the first surface to the second surface of the substrate; and
a drive device that rotates the substrate.

2. The light source device according to claim 1, wherein
the light guide optical system guides most part of the light from the excitation light source to a first surface of the phosphor wheel, and combines transmitted light that is transmitted through the opening and the fluorescent light to generate combined light;
at a same time, a residual part of the light from the excitation light source propagates through the light guide optical system in a direction different from a direction of the transmitted light without passing through the opening of the phosphor wheel and becomes backward traveling light that reaches a second surface of the phosphor wheel,
the light processing region has a diffusion layer that diffuse-reflects the backward traveling light, and
the color wheel is provided at a position where the combined light is incident.

3. The light source device according to claim 1, wherein the color wheel includes a filter that transmits red light and blue light and reflects light other than the red light and the blue light.

4. The light source device according to claim 3, wherein the phosphor wheel is provided with a diffusion layer on the second surface that is a back surface of the phosphor region that corresponds, on the first surface, to the filter.

5. The light source device according to claim 4, wherein the diffusion layer has a fine uneven structure.

6. The light source device according to claim 1, wherein
the excitation light source emits blue light with first polarization,
the light source device further comprising a dichroic mirror that is the light combining element and is provided at a position between the excitation light source and the phosphor wheel, the dichroic mirror transmitting the blue light and reflecting the fluorescent light, and
the dichroic mirror has a transmittance for the blue light with the first polarization higher than a transmittance for blue light with second polarization having a polarization direction different from a polarization direction of the first polarization.

7. The light source device according to claim 6, wherein the first polarization is P-polarization and the second polarization is S-polarization.

8. The light source device according to claim 4, wherein
the phosphor wheel includes a plurality of fins on the second surface that is a back surface of the phosphor region corresponding, on the first surface, to the filter, and
the diffusion layer is provided on side surfaces of the fins and a bottom surface between each of the fins and another of the fins.

9. The light source device according to claim 8, wherein the diffusion layer is also provided on top surfaces of the fins.

10. A projection-type video display device comprising the light source device according to claim 1.
